(19) United States
(12) Patent Application Publication
(10) Pub. No.: US 2005/0253392 A1
(43) Pub. Date: Nov. 17, 2005

(54) Mechanical energy multiplier with long lasting accelerator cum brake

(76) Inventors: Babubhai Nanubhai Patel, Cerritos, CA (US); Vipul Babubhai Patel, Cerritos, CA (US)

Correspondence Address: Babubhai Nanubhai Patel;Apt #263, 18427 Studebaker Rd, Cerritos, CA, 90703, US

(21) Appl. No.: 10/846,899

(22) Filed: May 17, 2004

(51) Int. Cl. H02P 9/04; B61C 9/38; B60L 11/02

(52) U.S. Cl. 290/1 R

(57) ABSTRACT

Present embodiment of the our invention can multiply require capacity of mechanical energy once filled in the invention as a permanent reserved by using the reserve of the internal energy again and again through size difference of to uneven sized gears having specific constructions and arrangements and through other parts. Where two or four simple gears having even require size, springs, two shafts and other parts helps to reserve require capacity of mechanical energy permanently in the invention and to convey require capacity of mechanical energy in the invention and in other machine for use of it. It does not require any kind of fuel for producing mechanical energy. The invention utilize mechanical or electrical controlling action producing parts having very slight rpm difference or require rpm difference between the parts and require pressure between the parts or by electrical force & it's connections with speed elevation cum reduction gears and other parts. Which gives require long working life and require higher controlling capacity to it. It can be utilize any where, where mechanical energy is require and also to provide require mechanical energy to any space machine of any size as described with drawings.

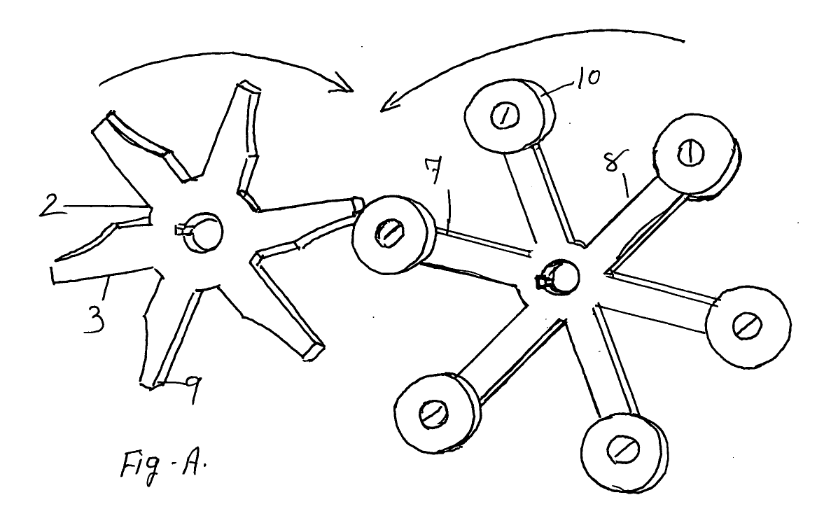

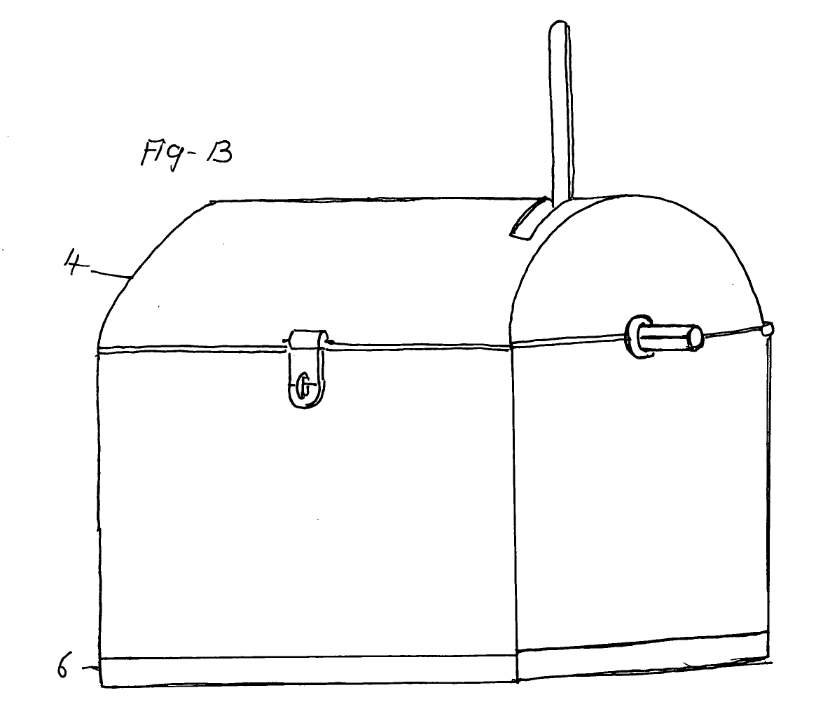

### FIELD OF THE INVENTION

The mechanical energy multiplier with long lasting accelerator cum brake is a mechanical invention. Which is related to combustion kind engines which provide require mechanical energy for various require use. It also related to parts which provide require mechanical energy to any power plant. As such it can be utilize any where, where mechanical is require. It does not require any kind of fuel for producing any require capacity or amount of mechanical energy. The invention can be utilize in place of any combustion kind of engine such as in any vehicle, any sea vessel, any aircraft, any tractor, any article and any machine where mechanical energy is require.

It can be also utilize to provide mechanical energy for spacecraft and satellite with powerful advantages over old methods of getting mechanical energy for these. Due to this invention any one of above machine do not require any kind of fuel for working of these for any require time.

### BACKGROUND OF THIS INVENTION WITH REGARD TO KNOWN MECHANICAL ART

According to new mechanical art, the mechanical energy multiplier with long lasting accelerator cum brake is a mechanical energy multiplying unit or product having long lasting mechanical energy controlling part.

So it can be utilize for any require use where mechanical energy is require for working of any vehicle, railway, sea vessel, any aircraft, spacecraft satellite or any other require machine without any kind of fuel economically. Thus it is an important part for any of of above and can be utilize in place of any combustion kind of engine or mechanical energy producing part of any project which provide mechanical energy, but this new part here does not require any kind of fuel for developing mechanical energy. Presently available kind of products for developing mechanical energy require fuel of any kind, require combustion action—heat and also produce noise and vibration in considerable extent also produce produces pollution and these are costly. The invention does not require water in developing mechanical energy.

Presently available mechanical energy producing devices utilize fuel and these are as per the law of conservation of energy and low of motion given by other scientists. This invention does not utilize any kind of fuel for developing mechanical energy, it also do not change any form of energy for developing mechanical energy and here mechanical action of higher require capacity than reaction can be created permanently to multiply mechanical energy for any require time and use.

This invention provides best option to use it in place of any combustion kind of engine and other parts producing mechanical energy in various faculty of science for working of different kind of machine and plant. The invention does not require any kind of fuel for producing mechanical energy and do not produce any pollution.

It produces very less noise and vibration. New controlling system of the invention provides same facilities as that of automatic transmission gear system of present vehicles and any other machine.

By utilizing advantages of invention many national and international problems can be overcome up to great extent without further more cost in planning and execution to overcome that problems.

### OBJECTS AND ADVANTAGES

First and prime object behind this invention is to provide very economical and innocent device which can provide require mechanical energy to use it in place of any combustion kind of engine and any other place to provide require mechanical energy without any fuel and any pollution economically.

Second object behind this invention is to provide better help in solving many national and inter national problems through advantages of this invention.

Further object behind this invention is to provide a product which can provide mechanical energy in any require capacity for any require use and for satellite and space craft.

Further object behind this invention is to provide a mechanical energy producing device which can provide require mechanical energy with considerable less noise, heat and vibration and also without any pollution and fuel.

Other object behind this invention is to provide a portable independent device which can provide require mechanical energy without any fuel to any product which require mechanical energy economically.

### SUMMARY OF THE INVENTION

The mechanical energy multiplier with long lasting accelerator cum brake comprises two main parts. One is mechanical energy multiplying part and other is long lasting accelerator cum brake part.

As per new mechanical art the mechanical energy multiplying part of this invention utilize fact that a rod of require strength and spring ness or a spring of require spring ness can lift many times more weight than its weight and positive assumption that it is possible to create mechanical action of higher require capacity than reaction permanently to multiply require mechanical energy for any require time for any require use. So the invention can be use in place of any combustion kind of engine and any other place where mechanical energy is require economically.

### BRIEF DESCRIPTION OF ATTACHED DRAWING

Drawing is in upright condition.

Fig -A.

A row, a part of a bigger sized gear 1 having require number of parts, rows of the gear, each part or each row 7 is having require number of specific kind of sprockets 8.

A smaller gear 2 having require number of circular rows, parts _3_each having require number of specific kind of sprockets 9_{—}

Rollers 10 of sprockets of the bigger gear part for reducing friction in between the smaller and the bigger gear parts of the invention.

Sprockets 9 of the smaller specific gear having specific shape and construction in the each part and sprockets of the smaller gear 2.

Sprockets 8 of a part of the bigger specific gear having a roller 10 near end of each sprocket to reduce friction in between the smaller gear 2 and the bigger gear 1 parts during working.

Fig. B

Final outer view the invention

lever regulating mechanical energy and working of the invention 5.

Base of the invention 6

closure 4.

### DETAILED DESCRIPTION OF THE INVENTION

According to new mechanical art the invention mechanical energy multiplier with long lasting accelerator cum brake comprises two main parts one is mechanical energy multiplier and other is long lasting accelerator cum brake for controlling mechanical energy output of the mechanical energy multiplier at any require stage for any require time, Which have very long working life.

The mechanical energy multiplying part comprises two simple gear having predetermine even require size. One of these gear have require construction to arrange mechanical energy filling parts to fill require capacity of mechanical energy once in the invention after arrangement of require parts, and after keeping brake action of the long lasting accelerator cum brake part at fill require capacity, through help of other parts of the invention. One simple gear_ is arranged in idle relative manner with respect to a shaft of a smaller gear_2 having specific construction. Other simple gear_ is arranged rigidly on a shaft of a bigger gear_1_having specific construction.

All these four gears are arranged on a base 6 through the shafts and brackets. The mechanical energy multiplying part is connected with a require shaft of the long lasting accelerator cum brake part through a shaft of the bigger gear_1_having specific construction. Drawing is in upright condition.

The smaller gear_2_having specific construction have predetermine size and predetermine number of sprockets and have a shaft. The gear 2_ have require number of sprockets_9_ in each circular part, row to keep require space in between the sprockets at near end of the sprockets_9 and have require number of such circular parts or rows to complete 360 degree of action or more during one rpm of the gear. The each circular row 3 of the sprockets have require space in between the rows to facilitate its working as the bigger gear 1 working with this smaller gear_2_ have a roller 10 at near end of each sprocket. The each sprocket 9 of the smaller gear have require specific construction of the sprockets and gear as in drawing to produce action of a maximum part of every rpm through each sprocket of the smaller gear 2 and the bigger gear 1.

Which produce require continuous pressure on the bigger gear during each rotation to rotate the bigger gear with equal rpm as that of the smaller gear_2_with increase in capacity of the internal energy through internal mechanical energy which is filled in the invention only one time. Shape of sprocket at near end of each sprocket in the smaller gear as shown in the drawing is not exact practicable shape, it just show that the each part of the gear 2 having specific kind of sprockets require a definite unusual construction in each part.

The bigger gear_1 have predetermine size and predetermine require number of sprockets 8 in each circular row to keep require space in between the sprockets at near end of the sprockets for require sized roller 10 at near end of each sprocket for require friction reduction in between the gears _2 & 1. The bigger gear_1_have require number of such rows 7 parts at require distance in between the parts to complete one rpm 360 degree or more than 36o degree of acting rotation of the bigger gear 1. The shafts of the gears have predetermine distance in between the both to form a predetermine require angle in between the sprockets of the smaller gear 2_and the bigger gear_1_to get require overlapping action on junction of the sprockets for getting require function from the invention. The shafts have predetermine heights from base of the invention to get utmost increase in internal capacity of mechanical energy through mechanical energy what is filled once after arrangement of require parts of the invention.

The mechanical energy filling parts comprises springs and other parts arranged on the smaller gear shaft and on the simple gear arranged in idle relative manner with respect to shaft of the smaller gear_2. The mechanical energy is to be filled by require machine tools manually after keeping brake of the invention at full require stage or by other mean.

The mechanical energy which got filled once in the combination gets reserved permanently in the combination and acts continuously on the shafts. And capacity of the mechanical energy which got filled once, get multiply during its way to gears and shafts and in terms of amount as per time allowed for working of the invention during working of the invention.

Here in this case the smaller gear_2 rotates the bigger gear_1 without reducing rpm of the bigger gear with increase in capacity of internal mechanical energy due to size difference of the gears having specific construction and simultaneous action of the working parts of the invention and due to construction and arrangements of parts of the invention.

This increase in energy is due to simultaneous actions of the working parts of the combination, size difference of the gears having specific kind of sprockets and the rollers of the bigger gear which reduces friction in between the gears up to great extent during working. This increase in capacity of internal mechanical energy occurs before the gears start their movement and also during their working due to pressure of the internal energy. Movements of the parts of the combination get start through the internal capacity of mechanical energy which acts continuously at junction of the sprockets of the smaller and bigger gear as there is a difference of require capacity of mechanical energy at any one point at junction of the sprockets at outer diameter part of these specific gears, which provide require working force behind the mechanical energy multiplying action.

During working and utilizing the invention it utilize the internal capacity of mechanical energy again and again for multiplying mechanical energy. Which is more than reaction due to the mechanical energy filling done in the invention once after arrangement of require parts, size difference of the specific kind of gears 2 &1, simultaneous action of the working parts of it and due to the rollers which reduces internal friction up to great extent and due to specific arrangement of the parts of it. The internal mechanical energy existing at the junction of the smaller and the bigger gear having specific kind of construction also get multiply during its way to any shaft due to diameter difference of both. i e, in between the junction of the sprockets and the shafts.

This indicates that it is possible to create mechanical action of higher require capacity than reaction permanently to multiply mechanical energy through a mechanical contrivance for any require use. The invention dose not change any form of energy during developing mechanical energy as per law conservation of energy.

It is also not a perpetual motion only as the combination can be utilize for any require use. The permanent reserved capacity of mechanical energy acting continuously do not get exhaust any time. It is economical, it does not produce any pollution, produces very less noise, very less vibration, and very less heat. It dose not require any combustion action for producing mechanical energy.

As per construction of the invention very smaller size to any bigger sized invention can be construct having very smaller capacity to any require higher capacity, for any require use as per mechanical energy requirement. It can be utilize in place of any combustion kind of engine in any vehicle, any railway, any sea vessel, any air craft, any tractor, any other machine, any article, satellite, and space craft as an important part of above to run any of above economically without fuel and any pollution. Here it does not require any kind of fuel for any time. The other part the long lasting accelerator cum brake comprises require number of speed elevating cum speed reduction gears connected with friction developing and controlling parts through gears The friction developing and controlling parts comprises brake drums and brake shoe having require construction and connected with respective onside gear and which rotates the drums with very slight speed difference in between the both during working through energy of the mechanical energy multiplying part_ A to reduce depreciation of friction developing parts up to great extent. The brake drums_ are fixed in idle relative and in relative manner on a shaft_ with respect to the shaft_ as per requirement.

This reduction in depreciation of the friction producing parts depends on rpm require to complete one rpm difference in between the both brake drums. More is rpm require to complete the one rpm difference in between the brake drums _ more less is the depreciation of the brake drums.

The speed elevating gears reduces stress in between the brake drums for given number of times which also increase working life of the brake drums up to great extent. The speed elevating cum speed reduction gears also multiply friction in the combination during applying brake thus it also increases capacity of the mechanical energy controlling parts for given number of times than applicable controlling action friction by lever 5 of combination. A lever 5_having require construction is arranged on a shaft near a bracket having require construction and arrangements to apply require pressure for require time in between the the brake drums and to keep it at one require stage for require time for controlling the mechanical energy at any require stage for any require time through the lever 5 and the bracket.

The brake drums have a spring of require tensile strength in between the both and an other spring on a side of a require brake drum to get require positive result from these brake drums. A bracket_ and the lever_5_are calibrated for different require stages to get any require calibrated output of mechanical energy when require or zero output. Any old brake system can be utilize where only stopping and starting action of the energy multiplier is require from the energy controlling part.

The invention has a hydraulic system constructed arranged in the combination to increase the energy controlling capacity of the long lasting accelerator cum brake when require for comfortable control of the mechanical energy and the brake action in many kind of use of the invention such as in any vehicle and any other machine.

The hydraulic system for controlling action comprises a oil cum air chamber, internal presser regulating valves, a internal presser release valve, springs, a non return valve introducing liquid in the oil cum air chamber through a pump getting mechanical energy for working from the energy multiplying part and also comprises a part regulating working of the hydraulic system. Capacity of the mechanical energy controlling part can be also increase up to require extent by increasing friction multiplying capacity of the energy controlling part for given number of times.

The invention also has a positive, reverse and neutral motion producing part comprising a chain, chain wheels, gears a motion selecting lever an additional shaft, brackets, a motion converting part and other parts when to use the invention for any vehicle and like machine or any large capacity machine.

The mechanical energy multiplier with long lasting accelerator cum brake also comprises require lubricating constructions and arrangements to lubricate require working parts of the energy multiplier to reduce depreciation.

From drawing and description it can be see that very smaller to very bigger mechanical energy multiplier having very small to very large capacity can be construct, similarly it is same about size for different require use.

In the long lasting accelerator brake part in place of the brake drums rotor and stator part of an electric motor can be arranged to develop different require capacity of electromotive force for require mechanical energy controlling action which multiply within the combination. Here require direct electric current is to be provide through an D.C. generator of require capacity working through energy of an additional mechanical energy multiplier. A differential electrical switch regulates the energy regulating force development and a hand brake is arranged to stop reverse speed at require stage and to stop the energy multiplier when require. This electrical method of developing require mechanical energy opposing force in the mechanical energy controlling part of the invention have very great long working life and is specifically useful for spacecraft. This long lasting accelerator brake part provides same facilities as that of automatic transmission gear system of any vehicle with very nominal requirement of energy for working of this part. Old manual gear system and automatic transmission gear system are un useful herewith this mechanical energy multiplier to use it in vehicle and where different capacity of the energy is require for different require time, as since very beginning only full require capacity of the mechanical energy is available. The invention have require lubricating construction and arrangements which provide require lubrication to working parts of the invention to reduce depreciation.

Capacity of the mechanical energy multiplier can be measure in terms of horse power, tensile strength, or circular pressure as per individual category wise use of the invention.

The mechanical energy multiplier with long lasting accelerator cum brake can be utilize to provide require mechanical energy for working of any vehicle, any sea vessel, any aircraft, any tractor, any article, any plant, any satellite, any space craft any other machine without any fuel and without any pollution for any length of time economically.

Working of the invention with more force in invention is indicate that the invention is capable to work with any amount of load with require force for any require time without any kind of fuel and can be operate with any amount of load depending capacity of the invention. It indicate that it is not only perpetual motion.

Final View of the Invention

Fig -B . The invention has a closure 4 to protect the invention from dust and to avoid accident during working of the invention.

Operation and Uses of the Mechanical Energy Multiplier with Accelerator Cum Brake

As the invention have require capacity of permanent reserve force acting in positive directions on the shafts of the gears after filling require capacity of mechanical energy only once after arrangement of require parts of the invention, the small gear_2 produces require pressure force on the bigger gear 1 due to the permanent reserve of internal mechanical energy where the energy get increase during its way to the simple gears and to the small gear again due to simultaneous action of the working parts of the invention and size difference of the small and the bigger gear, which increases capacity of internal mechanical energy even during working of the parts of the invention. Which rotates the working parts of the invention with any load attached to it depending up on capacity of the invention during working of the invention.

The shafts get start rotating when the brake action is released through a lever_5_up to require stage. The shafts can rotate with load of working parts and any load attached to a shaft with require capacity of mechanical force depending upon stage of the brake action which allows require capacity of mechanical energy output for working, and also depends on capacity of the mechanical energy multiplier.

It also over come friction and air resistance due to working of working parts of the invention

Working capacity of the invention depends on difference between full total capacity of the invention and capacity of the brake action at any require controlling stage. The brake action can be release up to require stage by moving the lever 5_in require direction up to require stage. Which decreases pressure in between the brake drums up to require stage and when the energy controlling action becomes less than the full mechanical energy multiplying capacity of the mechanical multiplying part A up to require stage. The invention get start and its capacity to do require work depends on difference between full capacity of the invention and capacity of the energy controlling action at any stage of the controlling action of the invention. The mechanical energy also multiply during its way to any shaft from the junction of the sprockets due to diameter difference of the both.

Due to even circular load on the shafts of invention it produces even circular motion during working and also produces less vibration.

During working of the invention the brake drums rotates in same direction with very slight speed difference in between the both, it completes one rpm speed difference in between the both when the brake—drums completes many thousands rpm, so it reduces depreciation up to great extent for given number of times. Here the friction gets multiply for given number of times in the combination, so it reduces stress in between the brake drums for given number of times.

Which also increases working life of the the friction producing parts and also increases capacity of the energy controlling parts for given number of times as per requirement.

Capacity of the energy controlling part can be increase by increasing the friction multiplying capacity of the energy controlling part through the speed elevating cum speed reduction gears & also by combined arrangement of the energy controlling parts and a hydraulic system having require constructions and arrangements which utilize internal mechanical energy can be utilize to control the mechanical energy multiplier as per individual category wise requirement of the invention for require use of the invention and for more comfort.

Similarly rotor and stator parts of an D.C. electric motor getting power from a D.C generator and an additional mechanical energy multiplier also can generate electromotive mechanical energy controlling action of require capacity through a deferential electrical switch. Which get multiply mechanically in the combination for given number times through speed reduction gears to control mechanical energy of the mechanical energy multiplier part, it can be utilize when require.

To stop reverse rpm at require stage an additional brake is require here. As the invention is capable for working even with any require amount of load it indicate that it is not only perpetual motion.

When to stop working of the invention the brake action of energy controlling part is to be make up to equal capacity as that of the energy multiplying part which stops the working of the invention.

when ever require a chain, chain wheels, a motion converting part, gears and a motion selecting part can be arranged in the invention. Which provides require direction motion or neutral motion when require to an energy providing end of a shaft for require use of it.

The lubricating construction and arrangements provides require lubricant to working parts of the invention to reduce depreciation of these parts.

Any old brake system can be utilize when only starting and stopping of the mechanical energy multiplier part is require.

Thus as per the invention it not does require to change any form of energy for producing mechanical energy unlike law of conservation of energy and it also do not require combustion for developing mechanical energy.

And here it is possible to create mechanical action of higher require capacity than reaction acting permanently in require positive direction to multiply mechanical energy for any require time and use

As material of construction of the invention have strength in zero weight space also it can work to provide require mechanical energy to any machine in zero weight space i.e. spacecraft.

The closure protects invention from dust and avoids accident during working of the invention. The invention can be utilize any where, where mechanical energy is require, and in place of any combustion kind of engine for working of any vehicle, any aircraft, any railway, any tractor, any sea vessel, any plant and for satellite and space craft or for any other article where mechanical energy is require. And as there is no combustion action and there is no requirement of any kind of in producing mechanical energy, there is very less noise, vibration and heat during working of the invention

From description and working a new scientific principle—a new scientific law can be workout that it is possible to develop mechanical action of higher require capacity than reaction permanently to multiply mechanical energy for any require time and for any require use through a mechanical contrivance.

The mechanical energy multiplier with long lasting accelerator cum brake having any require capacity can be construct for any require use.

Capacity of the invention depends on size of the invention, internal capacity of mechanical energy what is filled in the invention after arrangement of require parts of the invention, and size, construction, arrangement of parts of the invention, and of number of parts of the invention.

It is apparent to those who skilled in the art that that various equivalents and embodiments of this invention can be resorted to those which fall within scope and spirit of the invention disclosed and claimed in the specification with illustrative drawing.

1. For a mechanical energy multiplier with long lasting accelerator cum brake comprising a mechanical energy multiplying part and a mechanical energy controlling part; wherein the mechanical energy multiplying part comprises two or four simple even sized gears constructed arranged on a base through two shafts, brackets and other parts to multiply require capacity of mechanical energy through other parts of the invention and internal mechanical energy once filled in the invention after arrangements of require parts of the invention; wherein require number of the simple gear is fixed in idle relative manner with respect to shaft or shafts and have require construction and arrangements to fill require capacity of mechanical energy in the invention once after arrangement of require parts in the invention to multiply the energy through two require uneven sized gears having specific kind of constructions and arrangements arranged in the invention; wherein other simple gears are fixed rigidly to the other shaft to receive and multiply the internal energy during working; wherein require mechanical energy is to be fill through require machine tools manually or by other means after arrangement of require parts in the invention having springs other mechanical energy filling parts; wherein two specific require kind of require uneven sized gears have a smaller gear having specific construction of sprockets and predetermine space in between the sprockets is arranged on a shaft to rotate a bigger gear having require size and specifically constructed sprockets each having a roller near end of each sprocket, arranged on other shaft to receive and multiply the internal energy through simultaneous action of the parts, size difference of the uneven sized gears and other parts of the invention; wherein the internal energy which got filled gets reserve permanently and acts continuously on working parts of the invention; wherein the energy multiplying part is combined with a old kind of brake system or long lasting accelerator cum brake to control the mechanical energy multiplier at stopping stage and to start it when require or to control it at any require stage of capacity for any require time to utilize the invention for any require use where mechanical energy is require; wherein the long lasting accelerator cum brake part comprises brake drums and a brake shoe or other friction developing parts for developing it's friction through it's very slight rpm difference and different require pressure in between the parts during working to produce require controlling action with great reduction in depreciation of friction producing parts for require long working life of the multiplier controlling part; wherein the friction controlling parts are connected with speed elevation cum reduction gears and to the energy multiplying part in the contrivance to multiply friction of friction developing parts during working for require higher controlling capacity of the part and to increase long working life of the same up to require extent; wherein the energy controlling part comprises a lever and a bracket having require construction and arrangements to develop require pressure in between the friction producing parts for require time by the lever and the bracket and other parts; wherein the contrivance comprises any other part to increase capacity of controlling and comfort of the controlling function; wherein the contrivance comprises reverse motion and other require functions producing parts to make the invention more use full for any require machine; wherein the contrivance comprises electrical opposing force developing arrangement in place of the friction developing parts for control of the energy multiplier & for very great increase in working life of the controlling part, the electrical parts developing the energy controlling action parts are again connected speed elevation cum reduction gears and the energy multiplying part to rotate the parts with require rpm difference and to increase capacity of the controlling part; wherein the invention have require lubricating arrangement to lubricate require parts to reduce depreciation of working parts; wherein the invention comprises a closure to protect it from dust and to avoid accident during working; wherein the contrivance which can provide require mechanical energy for working of any aircraft any vehicle, any tractor, any sea vessel, any power plant, any rail way, any sized space machine, satellite, any article or any machine to run any of above without any fuel for any require time without pollution through multiplying the internal mechanical energy.

2. for the mechanical energy multiplier with long lasting accelerator cum brake or part thereof having novel features devised for multiplying mechanical energy for any require time and for any require use and for controlling the mechanical energy multiplier.

3. For a new scientific principle—a new scientific law that it is possible to develop mechanical action of higher require capacity than reaction permanently in a mechanical contrivance to multiply mechanical energy for any require time and use.

4. For the mechanical energy multiplier with long lasting accelerator cum brake as described in the specification with reference to drawings and for embodiments of it.
